(19) United States
(12) Patent Application Publication
(10) Pub. No.: US 2012/0230676 A1
(43) Pub. Date: Sep. 13, 2012

(54) TURN-UP AND LONG TERM OPERATION OF ADAPTIVE EQUALIZER IN OPTICAL TRANSMISSION SYSTEMS

(76) Inventors: Fan Mo, Hinckley, OH (US); Sameep Dave, Hinckley, OH (US); Christian Rasmussen, Lyngby (DK); Mehmet Aydinlik, Maynard, MA (US); Graeme Pendock, Carlisle, MA (US)

(21) Appl. No.: 13/413,873

(22) Filed: Mar. 7, 2012

Related U.S. Application Data
(60) Provisional application No. 61/449,812, filed on Mar. 7, 2011.

(51) Int. Cl. H04J 14/06; H04B 10/08

(52) U.S. Cl. 398/25; 398/65

(57) ABSTRACT

In an optical transmission system which utilizes polarization multiplexing, a receiver includes an adaptive equalizer which is adjusted at turn-up such that two polarization modes at the equalizer output are time aligned. The adaptive equalizer may be reset in a directed manner in response to an indication that one polarization mode is present at both the first and second outputs. Further, the dominant filters taps of the adaptive equalizer are maintained near a middle of a tap index range. The receiver may also include an interpolation function upstream of the adaptive equalizer and a symbol timing error estimation function that feeds a control signal back to the interpolation function, wherein the interpolation function causes the adaptive equalizer function and symbol timing error estimation function to receive an integer number of samples per symbol.

### CROSS-REFERENCE TO RELATED APPLICATIONS

Priority is claimed to U.S. Provisional Patent Application Ser. No. 61/449,812, filed Mar. 7, 2011, entitled METHOD FOR ROBUST TURN-UP AND LONG TERM OPERATION OF ADAPTIVE EQUALIZER IN OPTICAL TRANSMISSION SYSTEMS, which is incorporated by reference.

### BACKGROUND OF THE INVENTION

The present invention is generally related to optical transmission systems. One or more optical transmitters at a transmit terminal of an optical transmission system receive information in electrical form, perform various operations such as encoding, modulate an optical carrier with the encoded information, and send the modulated carrier out on an optical link. At a receive terminal, the individual optical carriers are demodulated and the resulting data decoded in order to recover the information that was given to the optical transmitter. Since an optical fiber may support two orthogonal polarization modes, it is possible to double the amount of information per carrier without doubling the spectral width of the modulated carrier by transmitting half of the information over one polarization mode and the other half of the information over the other polarization mode in accordance with a polarization multiplexing technique. In such systems coherent modulation/demodulation and digital equalization in the receiver helps to compensate for various impairments in the optical link and in the terminal equipment.

### SUMMARY OF THE INVENTION

In accordance with an aspect, and apparatus comprises: a receiver for an optical transmission system which utilizes polarization multiplexing, the receiver including an adaptive equalizer adjusted at turn-up such that two polarization modes at an equalizer output are time aligned.

In accordance with an aspect a method comprises: in a receiver for an optical transmission system which utilizes polarization multiplexing, the receiver including an adaptive equalizer, adjusting the equalizer at turn-up such that two polarization modes at an equalizer output are time aligned.

In accordance with an aspect an apparatus comprises: a receiver for an optical transmission system which utilizes polarization multiplexing, the receiver including an adaptive equalizer with first and second outputs, the adaptive equalizer being reset in a directed manner in response to an indication that one polarization mode is present at both the first and second outputs.

accordance with an aspect a method comprises: in a receiver for an optical transmission system which utilizes polarization multiplexing, the receiver including an adaptive equalizer with first and second outputs, resetting the adaptive equalizer in a directed manner in response to an indication that one polarization mode is present at both the first and second outputs.

In accordance with an aspect an apparatus comprises: a receiver for an optical transmission system which utilizes polarization multiplexing, the receiver including an adaptive equalizer for which dominant filters taps are maintained near a middle of a tap index range.

In accordance with an aspect a method comprises: in a receiver for an optical transmission system which utilizes polarization multiplexing, the receiver including an adaptive equalizer, maintaining dominant filters taps near a middle of a tap index range.

In accordance with an aspect an apparatus comprises: a receiver for an optical transmission system which utilizes polarization multiplexing, the receiver including an interpolation function followed by an adaptive equalizer function followed by a symbol timing error estimation function that feeds a control signal back to the interpolation function, wherein the interpolation function causes the adaptive equalizer function and symbol timing error estimation function to receive an integer number of samples per symbol.

In accordance with an aspect a method comprises: in a receiver for an optical transmission system which utilizes polarization multiplexing, the receiver including an interpolation function followed by an adaptive equalizer function followed by a symbol timing error estimation function that feeds a control signal back to the interpolation function, the interpolation function causing the adaptive equalizer function and symbol timing error estimation function to receive an integer number of samples per symbol.

### BRIEF DESCRIPTION OF THE FIGURES

FIG. 1 is a block diagram of an optical transmission system.

FIG. 2 Illustrates polarization multiplexing.

FIG. 3 is a block diagram of an optical transmitter.

FIG. 4 is a block diagram of an optical receiver.

FIG. 5 is a block diagram of a digital demodulator.

FIG. 6 illustrates an adaptive equalizer.

FIG. 7 illustrates filter tap magnitude under various link impairments.

FIG. 8 illustrates suboptimum equalizer turn-up leading to reduced long term robustness.

FIG. 9 illustrates improved equalizer turn-up for robust long term operation.

FIG. 10 illustrates tap wander during long term operation.

FIG. 11 illustrates equalizer response to sudden link impairment worsening with and without tap wander.

### DETAILED DESCRIPTION

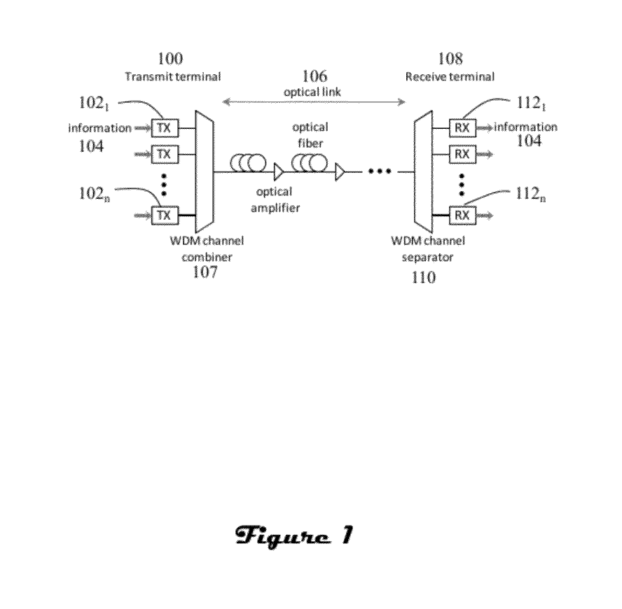

FIG. 1 illustrates an optical transmission system. At a transmit terminal 100, one or more optical transmitters 102₁ through 102. receive information 104 in electrical form, perform various operations such as encoding, modulate an optical carrier with the encoded information and send out on an optical link 106 via a channel combiner 107. The modulated carrier may be a wavelength division multiplex (WDM) channel. At a receive terminal 108, the individual optical carriers are demultiplexed via a channel separator 110 and provided to one or more optical receivers 112₁ through 112ₙ where the carriers are demodulated and the resulting data decoded in order to recover the information that was given to the optical transmitter.

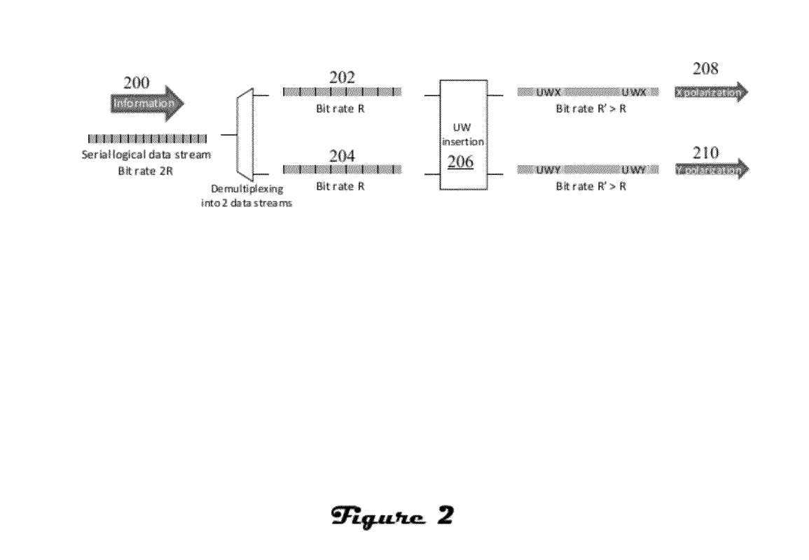

Referring to FIG. 2, at least one class of optical transmission systems relies on coherent modulation/demodulation and digital equalization in the receiver to compensate for various impairments in the optical link and in the terminal equipment. Because certain optical fibers support two orthogonal polarization modes, it is possible to double the amount of information per carrier without doubling the spectral width of the modulated carrier by transmitting half of the information over one polarization mode and the other half over the other polarization mode in accordance with a polarization multiplexing technique. In the illustrated example the two polarization modes generated by the transmitter are denoted “X” and “Y.” The incoming information 200 with bit rate 2R, which may include encoding for forward error correction etc., is split into two data streams 202, 204 with bit rate R into which unique bit patterns (“unique word,” or “UW”) may be inserted at regular intervals by UW insertion block 206. As the polarization multiplexed optical signal propagates through the optical link, the polarization will undergo random rotations and the two polarization modes will experience random coupling and, in general, different propagation delays. This distortion effect is known as Polarization Mode Dispersion (PMD). Due to the polarization rotations and PMD, it is not immediately possible to identify the two polarization modes at the receiver unless the two data streams modulating the two polarization modes are marked with unique bit patterns. These unique bit patterns may exist directly in the information sent over the optical link, e.g. frame alignment bits. Alternatively or additionally, unique bit patterns (or Unique Word, UW) can be inserted in the two data streams at regular intervals by UW insertion block 206 to enable unique identification of the polarization modes at the receiver and enable correct reconstruction of the logical serial data stream received by the transmitter over its electrical data interface. This is shown in the illustrated example where the two different UWs inserted in the X polarization and Y polarization data streams UWX and UWY. Insertion of the UW results in an increase of the bit rate per polarization from R to R′, generally less than 1%.

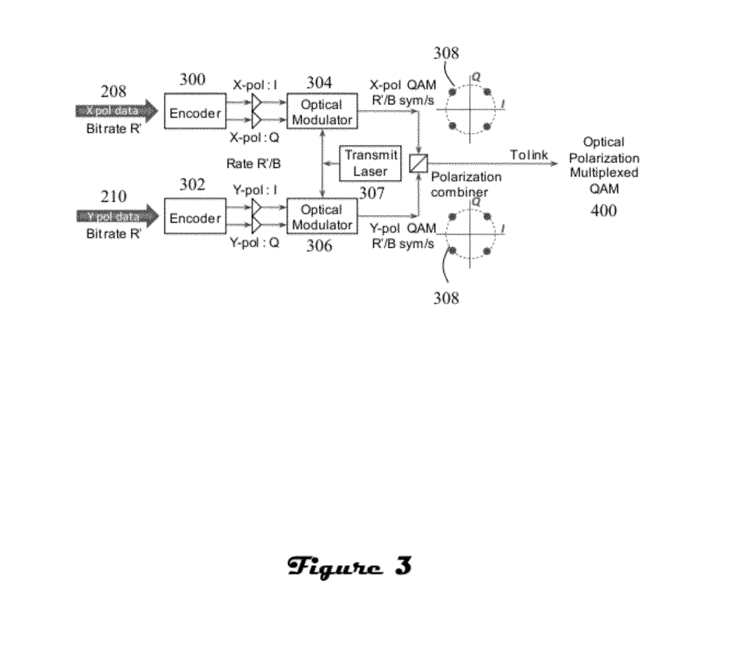

FIG. 3 illustrates the optical transmitter in greater detail. Referring to FIGS. 2 and 3, the X and Y polarization data streams 208, 210, potentially with UW inserted, drive two encoders 300, 302 that generate the analog signals that drive the optical modulators 304, 306 that impress modulation on a continuous wave from a laser 307. The symbol rate of the polarization modes depends on the number of bits encoded on each symbol, B. The constellation diagrams 308 indicate quadrature phase shift keying (QPSK) modulation (B=2), but the invention is not limited to QPSK and other modulation formats including but not limited to phase shift keying (PSK) and quadrature amplitude modulation (QAM) with fewer or more levels could be utilized.

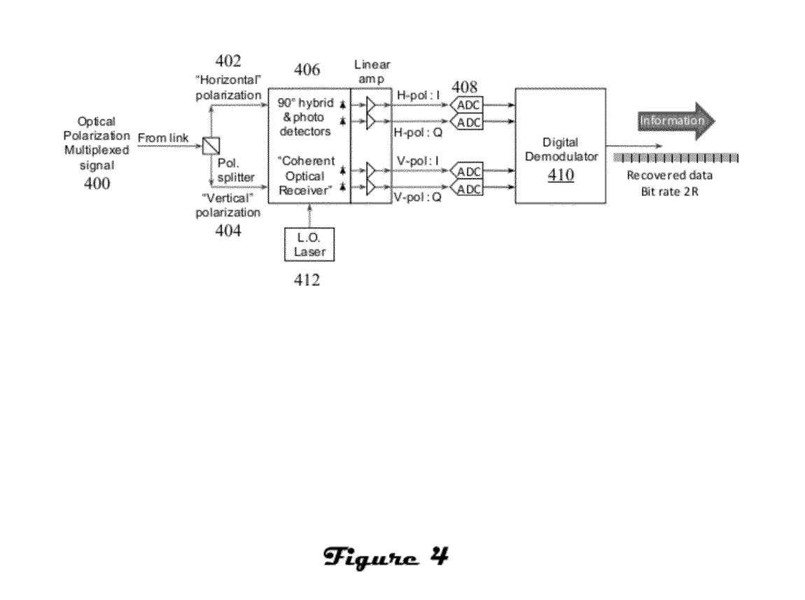

FIG. 4 illustrates the optical receiver in greater detail. The incoming polarization multiplexed signal 400 is split into two nominally orthogonal polarization components: “horizontal” (“H”) 402 and “vertical” (“V”) 404 which are provided to a coherent optical receiver block 406 including 90° hybrid and photo detectors. The outputs of block 406 are provided to analog to digital converters 408. Since it is not possible to maintain alignment of the polarization axes in the transmitter and receiver, the H polarization in the receiver will generally be neither the X polarization nor the Y polarization at the transmitter's output but a random linear combination of X and Y. The same is true for the V polarization. A digital demodulator 410 is operative to recover the original X and Y polarization signals from the H and V components in the receiver. In the coherent optical receiver block 406, the H and V components are combined with a continuous wave (CW) from a local oscillator laser 412 and downconverted to baseband in-phase (I) and quadrature (Q) components by the quadratic detection in the photo detectors. The frequency of the CW is nominally equal to the carrier frequency of the optical signal from the transmitter. After appropriate linear amplification with optional gain control, the I and Q components of the H and V polarizations are sampled in analog-to-digital converters (ADC) 408 to enter the digital domain for further digital processing. Satisfactory receiver performance is typically achieved with two samples per symbol (per polarization), but it is possible to undersample with some performance loss.

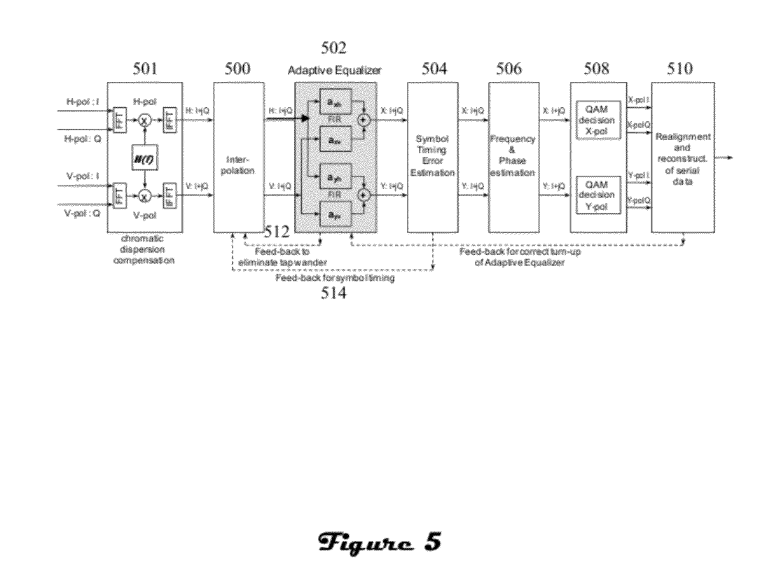

FIG. 5 illustrates the digital demodulator 410 (FIG. 4) in greater detail. Symbol timing is handled by an interpolation block 500 followed by an adaptive equalizer block 502 followed by a symbol timing error estimation block 504 with a symbol timing error feed-back 514 to the interpolation block. The I and Q samples of the two polarization modes are first processed in a chromatic dispersion compensation block 501 that compensates for the major part of the chromatic dispersion of the optical link. This operation may be implemented in the frequency domain. The next operation is timing interpolation in the interpolation block 500 to ensure that the downstream signal processing blocks receive an integer number of samples per symbol (per polarization), e.g. 2. The interpolation block is furthermore part of a control loop that utilizes a feed-back signal 514 from the symbol timing error estimation block 504 at the output of the adaptive equalizer 502 to fine tune the interpolation ratio so that the on-time samples at the output of the adaptive equalizer fall at the optimum sampling time in the middle of the eye. Signals from the symbol timing block 504 are provided to a frequency and phase estimation block 506, followed by a QAM decision block 508 and a realignment and reconstruction block 510.

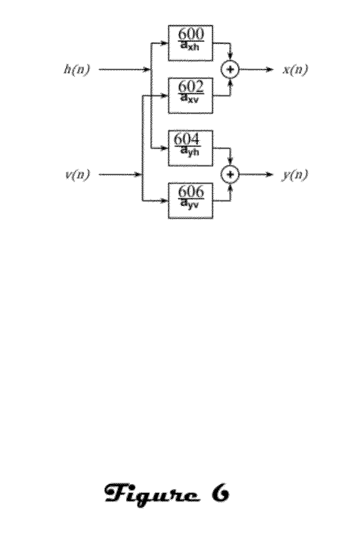

A possible structure of the adaptive equalizer 502 (FIG. 5) is shown in FIG. 6.

The adaptive equalizer 502 provides compensation of the randomly time-varying polarization rotation and polarization mode dispersion of the optical link to recover the X and Y polarization modes that are transmitted on the link by the transmit terminal. The adaptive equalizer also compensates for chromatic dispersion not removed by other optical or digital means, polarization dependent loss (the two polarization modes propagating through the optical link may experience different attenuation), non-ideal transmit and receive component transfer functions etc. Inputs h(n) and v(n) are the complex input samples (I+jQ) of the H and V polarization modes, respectively, and x(n) and y(n) are the complex output samples which under correct operation represent the symbols that were transmitted on the X and Y polarization modes, respectively. In one possible implementation, four filtering operations 600, 602, 604, 606 from the two inputs to the two outputs are finite impulse response (FIR) filters. Mathematically, the output samples from the adaptive equalizer can be expressed as:

$$x ( n ) = {\sum }_{m = 0}^{M - 1} {a}_{xh} ( m ) h ( n - m ) + {\sum }_{m = 0}^{M - 1} {a}_{xv} ( m ) v ( n - m )$$

$$y ( n ) = {\sum }_{m = 0}^{M - 1} {a}_{yh} ( m ) h ( n - m ) + {\sum }_{m = 0}^{M - 1} {a}_{yu} ( m ) v ( n - m )$$

where M is the number of complex filter taps in each of the four filters. Blind equalization algorithms such as the constant modulus algorithm (CMA) or decision directed least mean squares algorithm (DD-LMS) can be used for continuous update of the filter taps.

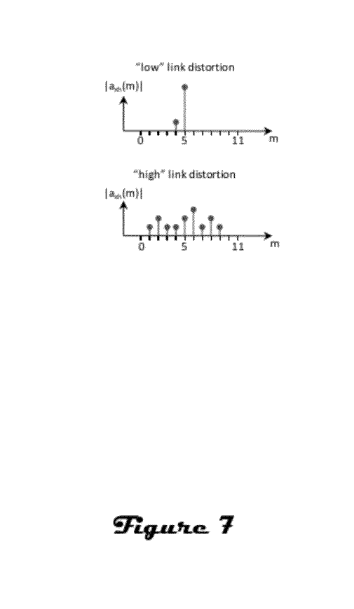

FIG. 7 illustrates how the filter taps respond to different levels of link distortion for a case where each of the four FIR filters have 12 filter taps. If the distortion level is low, only a few filter taps will be significantly different from 0 to equalize the link whereas all taps are required to deal with high levels of link distortion.

Referring again to FIG. 5, the frequency and phase estimation block 506 estimates and removes any frequency and phase offset between the TX laser in the transmitter and the local oscillator laser in the receiver. It is also possible that the frequency estimate is fed back to a block earlier in the chain of demodulator blocks (not shown in FIG. 5) where the frequency offset is removed digitally and/or that the frequency of the local oscillator laser is fine adjusted to match the TX laser frequency based on the frequency estimate. After removal of frequency and phase offset, the data is recovered from the signal samples in QAM decision block 508. It will be appreciated however that other modulation formats could be utilized. The QAM decision block 508 may include a differential decoding block if the data is differentially encoded in the transmitter. The data from the QAM decision block 508 is realigned and combined to reconstruct the data stream given to the transmitter in the realignment and reconstruction of serial data block 510. This block 510 detects and compensates for a possible relative delay of the X and Y polarization data due to PMD by looking for unique bit patterns in the data, e.g. UW inserted in the data stream at the transmitter.

### Turn-Up of the Adaptive Equalizer

Referring to FIGS. 5 and 6, when an adaptive equalizer relying on blind estimation for filter tap adaptation turns up from its initialization state (for instance aₓₕ(m)=aₓᵥ(m)=a_{yh}(m)=a_{yv}(m)=0 except aₓₕ(M/2)=a_{yv}(M/2)=1), the filter taps may adapt so that the same signal appears at both the “upper” and the “lower” equalizer outputs, e.g. both x(n) and y(n) may be samples of the X polarization mode. There are multiple techniques for detecting the situation where both equalizer outputs have converged to the same polarization. For instance, direct correlation of x(n) and y(n), detection of near zero determinant of the adaptive equalizer's transfer matrix in the frequency domain and the unique bit patterns in the X and Y data streams (inserted UW or unique pattern in the data stream given to the optical transmitter) can be utilized. Two methods may be employed for reinitializing the adaptive equalizer so x(n) is samples of one polarization mode and y(n) is samples of the other polarization mode. The first method is a simple loop where the equalizer is reinitialized repeatedly using the same initialization state (e.g. instance aₓₕ(m)=aₓᵥ(m)=a_{yv}(m)=a_{yv}(m)=0 except aₓₕ(M/²)=a_{yv}(M/2)=1) until random noise or changes of the link lead to the desired state where different polarization modes exist at the two equalizer outputs, at which point the reinitialization loops is stopped. The second method is directed reinitialization, which is described in detail in greater detail below.

### Directed Reinitialization of Filter Taps

The spectrum of the two polarization modes at the output of the optical link can be expressed as a 2×2 matrix transfer function H (f) times the spectrum of the two polarization modes at the input of the link:

$$( \begin{matrix}{X}_{out} ( f ) \\ {Y}_{out} ( f )\end{matrix} ) = H ( f ) ( \begin{matrix}{X}_{i n} ( f ) \\ {Y}_{i n} ( f )\end{matrix} )$$

H (f) includes all linear distortions such as chromatic dispersion, polarization rotation, polarization mode dispersion, and polarization dependent loss. Assuming the polarization dependent gain/loss is negligible, H(f) can be written:

H(f)=kU(f)

where k is a complex factor describing the link net gain and a possible common phase shift of the two polarization modes and U(f) is a unitary matrix,

$$U ( f ) {U}^{†} ( f ) = ( \begin{matrix}1 & 0 \\ 0 & 1\end{matrix} ) .$$

The ideal transfer function of the receiver R(f) exactly undoes the link transfer function:

$$R ( f ) H ( f ) = ( \begin{matrix}1 & 0 \\ 0 & 1\end{matrix} )$$

$$i . e . \\ R ( f ) = \frac{1}{k} {U}^{†} ( f )$$

$$meaning that$$

$$R ( f ) {R}^{†} ( f ) = \frac{1}{{\vert k \vert}^{2}} ( \begin{matrix}1 & 0 \\ 0 & 1\end{matrix} ) = K ( \begin{matrix}1 & 0 \\ 0 & 1\end{matrix} )$$

where K is a real constant. The four elements of the receiver transfer function,

$$R ( f ) = ( \begin{matrix}A ( f ) & B ( f ) \\ C ( f ) & D ( f )\end{matrix} ) .$$

consequently satisfy these relationships:

|A|²+|B|²=|C|²+|D|²=K²

AC*+BD*=0

If A(f) and B(f) are known (transfer function for “upper” output of the equalizer, see below), the relationships can be satisfied by choosing C(f) and D(f) as follows:

$$C ( f ) = {B ( f )}^{*}$$

$$D ( f ) = - {A ( f )}^{*}$$

$$i . e . \\ R ( f ) = ( \begin{matrix}A ( f ) & B ( f ) \\ {B ( f )}^{*} & - {A ( f )}^{*}\end{matrix} )$$

The corresponding impulse response is

$$r ( t ) = ( \begin{matrix}a ( t ) & b ( t ) \\ {b ( - t )}^{* } & - {a ( - t )}^{*}\end{matrix} )$$

Given the architecture of the equalizer depicted in FIG. 6 and the definition of filter taps,

$$x ( n ) = {\sum }_{m = 0}^{M - 1} {a}_{xh} ( m ) h ( n - m ) + {\sum }_{m = 0}^{M - 1} {a}_{xv} ( m ) v ( n - m )$$

$$y ( n ) = {\sum }_{m = 0}^{M - 1} {a}_{yh} ( m ) h ( n - m ) + {\sum }_{m = 0}^{M - 1} {a}_{yv} ( m ) v ( n - m )$$

if the adaptive equalizer converges so x(n) and y(n) are the same signal, the values aₓₕ(m) and aₓᵥ(m) can be kept, and a_{yh}(m) and a_{yv}(m) can be reset as follows:

a_{yh}(m)=aₓᵥ*(M−m)

a_{yv}(m)=−aₓₕ*(M−m)

The equalizer will converge to the desired state where x(n) and y(n) are samples of different polarization modes after this reinitialization has been performed, even in the presence of polarization dependent loss.

### Power Balancing

The probability of initial convergence where the same signal appears at both equalizer outputs can be reduced if analog or digital power balancing techniques are applied. In particular, power balancing techniques are used to equalize average power of the two equalizer input signals, h(n) and v(n).

### Equalizer Maintenance for Long Term Operation

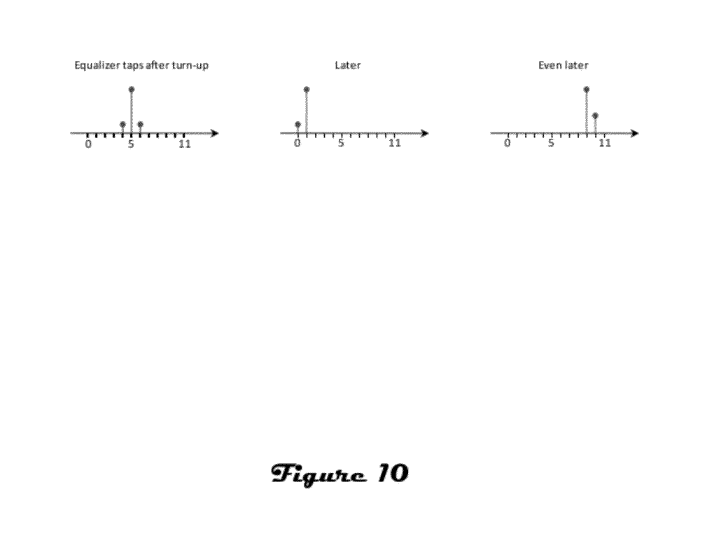

Referring to FIG. 10, once the adaptive equalizer is turned up, it will continuously maintain equalization of the time varying link impairments if these impairments don't exceed the compensation capability of the equalizer. Traditional filter tap adaptation algorithms such as CMA and LMS lack a mechanism for keeping the dominant filter taps centered near the middle of the FIR filter. Consequently, the taps may over time wander back and forth as illustrated due to the random noise in the system. Once the group of significantly non-zero taps approaches one of the edges of the filter (more precisely the minimum or maximum tap index), the wander will not continue in the direction that would push the significantly non-zero taps past the edge as this will lead to suboptimum equalization and the adaptation algorithm will automatically react by pushing the taps in the opposite direction to maintain the signal quality at the output of the adaptive equalizer.

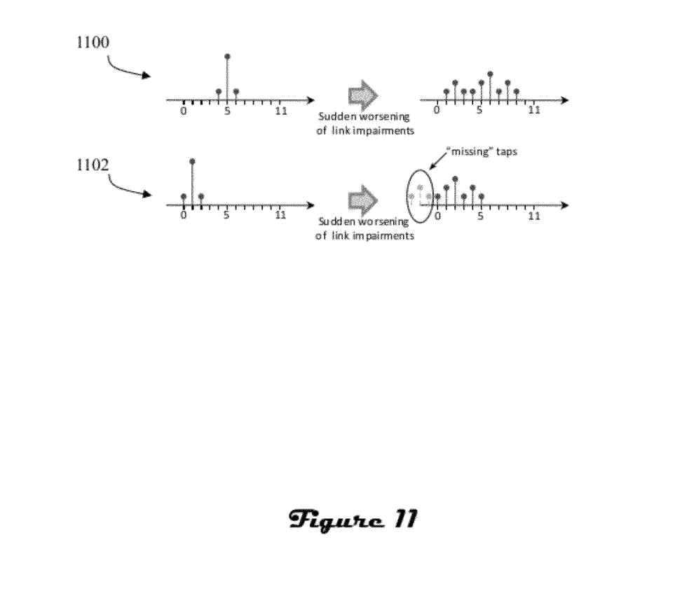

Referring to FIGS. 7 and 11, at 1100 the dominant taps are centered and the equalizer has taps available on both sides of the dominant taps are able to respond adequately to the sudden worsening of the link impairment. At 1102, the dominant taps have moved near the edge of the FIR filter due to tap wander and the equalizer does not have enough taps to respond adequately to the sudden worsening so equalization temporarily fails. To shift all taps to the right in case 1102 a symbol timing loop is utilized that is typically designed to be much slower than the adaptive equalizer to ensure low sampling time jitter (good noise filtering) and optimum steady state performance.

To avoid tap wander and ensure that the equalizer taps stay centered, the interpolation ratio in the interpolation block is frequently or continuously fine-adjusted to keep the dominant filter taps near the middle of the FIR filters. This can be accomplished using feed-back to eliminate tap wander 512. Various error signals can be generated from the filter taps to measure to what degree the dominant filter taps are centered. For example, an imbalance of the power of the Q leftmost filter taps and the power of the Q rightmost filter taps, where Q is a number between 1 and M/2, can be utilized such that error signal=eₓₕeₓᵥe_{yh}+e_{yv} where e_{rd}=Σₘ₌₀^{m=Q-1}|aᵣₛ(m)|^{p}−Σ_{m=M-Q}^{M-1}|aᵣₛ(m)|^{p}, rs=xh,xv,yh,yv and p is an integer and Q is a number between 1 and M/2. Also for example, distance of filter taps' center of mass from the middle of the FIR filter can be utilized such that error signal=eₓₕ+eₓᵥ+e_{yh}+e_{yv} where

$${e}_{rs} = \frac{{\sum }_{m = 0}^{m = M - 1} m \cdot {\vert {a}_{rs} ( i ) \vert}^{p}}{{\sum }_{m = 0}^{m = M - 1} {\vert {a}_{rs} ( i ) \vert}^{p}} - \frac{M}{2} ,$$

rs=xh, xv, yh, yv and p is an integer. Or:

$$Error signal = \frac{\begin{matrix}{\sum }_{m = 0}^{m = M - 1} m \cdot {\vert {a}_{xh} ( i ) \vert}^{p} + {\sum }_{m = 0}^{m = M - 1} m \cdot {\vert {a}_{xv} ( i ) \vert}^{p} + \\ {\sum }_{m = 0}^{m = M - 1} m \cdot {\vert {a}_{yh} ( i ) \vert}^{p} + {\sum }_{m = 0}^{m = M - 1} m \cdot {\vert {a}_{yv} ( i ) \vert}^{p}\end{matrix}}{\begin{matrix}{\sum }_{m = 0}^{m = M - 1} {\vert {a}_{xh} ( i ) \vert}^{p} + {\sum }_{m = 0}^{m = M - 1} {\vert {a}_{xv} ( i ) \vert}^{p} + \\ {\sum }_{m = 0}^{m = M - 1} {\vert {a}_{yh} ( i ) \vert}^{p} + {\sum }_{m = 0}^{m = M - 1} {\vert {a}_{yv} ( i ) \vert}^{p}\end{matrix}} - \frac{M}{2}$$

where p is an integer. The interpolation ratio in the interpolation block is fine adjusted to drive the above-described error signals to zero.

The tap wander is not problematic if the link impairment does not vary or varies only slowly. However, if the strength of the link impairment changes on a time scale shorter than the response time of the symbol timing loop involving the interpolation block 500, the adaptive equalizer block 502 and the symbol timing error estimation block 504, the tap wander may reduce the equalizer's ability to compensate for a rapidly worsening link impairment as illustrated in FIG. 11.

In accordance with another aspect, all equalizer taps may be shifted left or right corresponding to an integer number of symbol times if the error signal passes a certain threshold showing that the taps have wandered too far right or left. This operation can happen internally in the adaptive equalizer block and does not necessarily involve other blocks in the demodulator. On-time samples (e.g. 0) are skipped or inserted at the equalizer output to maintain synchronization if the equalizer taps are shifted. To illustrate this point, it is assumed that the adaptive equalizer receives two samples per symbol. As previously stated, the equalizer output is given by:

$$x ( n ) = {\sum }_{m = 0}^{M - 1} {a}_{xh} ( m ) h ( n - m ) + {{\sum }_{m = 0}}^{M - 1} {a}_{xv} ( m ) v ( n - m )$$

$$y ( n ) = {\sum }_{m = 0}^{M - 1} {a}_{yh} ( m ) h ( n - m ) + {\sum }_{m = 0}^{M - 1} {a}_{yv} ( m ) v ( n - m )$$

where even values of the time index n are assumed to correspond to on-time samples (the middle of the eye). Assume that a tap shift corresponding to one symbol time delay of the four FIR impulse responses takes place between time n₀, n₀ even, and n₀+2, i.e. aᵣₛ(m)→aᵣₛ(m+2), aᵣₛ(0)=aᵣₛ(1)=0 where rs=xh, xv, yh, yv. If no special action is taken, x(n₀+2)=x(n₀) and y(n₀+2)=y(n₀), showing that the tap shift creates duplicate on-time samples at the output of the equalizer unless one on-time sample is discarded when the FIR impulse responses are delayed. A similar analysis shows that when the FIR impulse responses are advanced corresponding to one symbol time, an on-time sample should be inserted in the data stream at the equalizer output to maintain synchronization. This sample can arbitrarily be chosen to be 0 and may cause a bit error.

Aspects of the invention may be implemented with computer program code stored on a non-transitory computer-readable medium. Such program code can be utilized by general purpose processors, purpose-built hardware, or both to achieve functionality.

### Equalizer Turn-Up for Long Term Operation

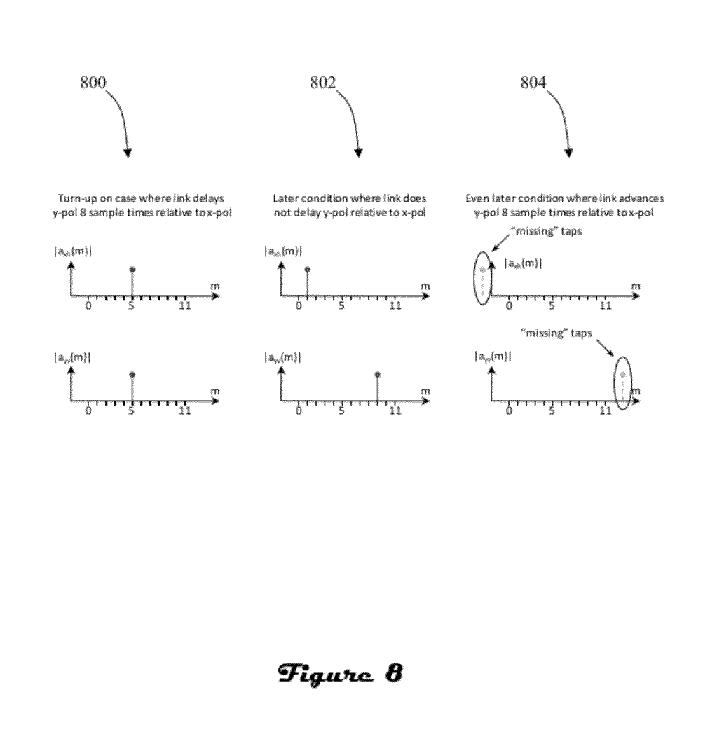

Referring to FIG. 8, equalizer turn up can be enhanced for improved long term operation. One factor that affects long term operation is randomly and continuously varying impairments in the optical link. To illustrate how suboptimum equalizer turn-up can limit the equalizer's ability to compensate continuously for time varying link impairments, considered where the H polarization of the receiver happens to be aligned to the X polarization of the transmitter. In this case Y and V will be aligned as well. Furthermore, consider where the polarization mode dispersion (PMD) of the link at the time of equalizer turn-up delays the Y polarization mode by exactly 8 times the time between two consecutive signal samples at the equalizer input. The initialization of the

equalizer (e.g. aₓₕ(m)=aₓᵥ(m)=a_{yh}(m)=a_{yv}(m)=0 except

$${a}_{xh} ( \frac{M}{2} - 1 ) = {a}_{yv} ( \frac{M}{2} - 1 ) = 1 )$$

which is as good an initial state as can be found without knowledge of the link) will provide compensation of this link apart from the link-induced relative delay of the X and Y polarization that propagates through the equalizer (aₓᵥ(m) and a_{yh}(m) will remain all zero because H is aligned with X and V with Y). Assuming that the equalizer relies on blind estimation, it does not have any knowledge of the expected data carried by the X and Y polarization and it consequently does not have any way of detecting a possible relative time delay between X and Y. The filter taps after the described convergence ensuring equalization at turn-up are shown in column 800.

Over time the physical environment of the fiber link will change due to temperature, mechanical disturbances, etc., causing the PMD of the link to change. It is for instance possible that the relative delay of the Y polarization relative to X polarization will go to 0. This is a continuous process that can be seen as a gradual delay of the X polarization and advance of the Y polarization. The adaptive equalizer will continuously track this gradual change of the relative delay by compensating for the delay of X, moving the dominant filter taps in aₓₕ(m) in the direction of smaller index (time advance) and the dominant filter taps in a_{yv}(m) in the direction of larger index (time delay). The equalizer state when the X and Y polarization modes are aligned in time is shown in column 802.

As a result of further changes in the optical link, it is possible to reach a state where the Y polarization is advanced relative the X polarization by, e.g. 8 times the time between two consecutive signal samples at the equalizer input. To track this change of the link, the equalizer would have to continue moving the dominant taps in aₓₕ(m) in the direction of smaller index (time advance) and the dominant filter taps in a_{yv}(m) in the direction of larger index (time delay). However, at some point, the number of equalizer taps will be insufficient to ensure continuous equalization of the link and the equalization will break down. This is illustrated in column 804.

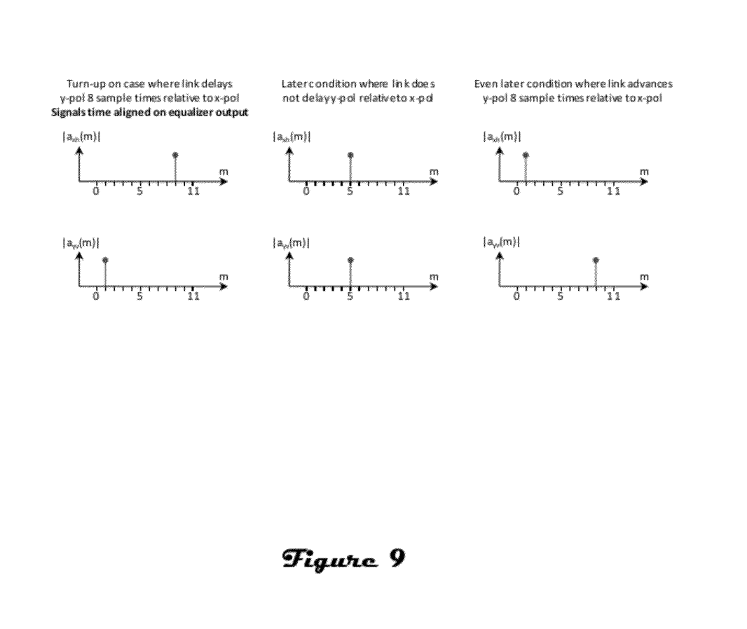

Referring to FIG. 9, the described equalizer problems may be avoided. Initially, the equalizer turns up as described above. If both equalizer outputs converge to either the X polarization data or the Y polarization data, one of the reinitialization methods described above is used. Once the equalizer has converged correctly, the realignment and reconstruction of serial data block 510 (FIG. 5) identifies the unique bit pattern (inserted UW or specific bit patterns in the date stream given to the optical transmitter) in the data streams for the X and Y polarization to establish a possible relative time delay. In the example shown in FIG. 8 the realignment and reconstruction of serial data block would detect that the Y pol data are delayed 8 sample times relative to the X pol data. This time delay information is then fed back to the equalizer block where the taps are shifted to ensure that the equalizer output signals x(n) and y(n) are aligned in time. At this point, the equalizer initialization is complete and the equalizer will have improved capability for tracking the time varying link impairments as illustrated, where the equalizer now handles the link impairment case in which it breaks down without the improved initialization.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. Apparatus comprising:
a receiver for an optical transmission system which utilizes polarization multiplexing, the receiver including an adaptive equalizer adjusted at turn-up such that two polarization modes at an equalizer output are time aligned.

2. The apparatus of claim 1 wherein the adaptive equalizer is adjusted at turn-up based on native unique bit patters in a data stream.

3. The apparatus of claim 1 wherein the adaptive equalizer is adjusted at turn-up based on inserted unique bit patters in a data stream.

4. A method comprising:
in a receiver for an optical transmission system which utilizes polarization multiplexing, the receiver including an adaptive equalizer, adjusting the equalizer at turn-up such that two polarization modes at an equalizer output are time aligned.

5. The method of claim 4 including adjusting the adaptive equalizer is adjusted at turn-up based on native unique bit patters in a data stream.

6. The method of claim 1 including adjusting the adaptive equalizer at turn-up based on inserted unique bit patters in a data stream.

7. Apparatus comprising:
a receiver for an optical transmission system which utilizes polarization multiplexing, the receiver including an adaptive equalizer with first and second outputs, the adaptive equalizer being reset in a directed manner in response to an indication that one polarization mode is present at both the first and second outputs.

8. The apparatus of claim 7 where the equalizer is reinitialized repeatedly using a particular initialization state until different polarization modes are present at the two equalizer outputs.

9. The apparatus of claim 7 including filter taps defined as
$$x ( n ) = {\sum }_{m = 0}^{M - 1} {a}_{xh} ( m ) h ( n - m ) + {\sum }_{m = 0}^{M - 1} {a}_{xv} ( m ) v ( n - m )$$
$$y ( n ) = {\sum }_{m = 0}^{M - 1} {a}_{yh} ( m ) h ( n - m ) + {\sum }_{m = 0}^{M - 1} {a}_{yv} ( m ) v ( n - m )$$
and where values aₓₕ(m) and aₓᵥ(m) are maintained if the equalizer converges so x(n) and y(n) are the same signal, and where a_{yh}(m) and a_{yv}(m) are otherwise reset as follows:
a_{yh}(m)=aₓᵥ*(M−m)
a_{yv}(m)=−aₓₕ*(M−m)

10. The apparatus of claim 7 wherein average power of the two equalizer input signals is equalized.

11. A method comprising:
in a receiver for an optical transmission system which utilizes polarization multiplexing, the receiver including an adaptive equalizer with first and second outputs, resetting the adaptive equalizer in a directed manner in response to an indication that one polarization mode is present at both the first and second outputs.

12. The method of claim 11 including repeatedly reinitializing the equalizer using a particular initialization state until different polarization modes are present at the two equalizer outputs.

13. The method of claim 11 including filter taps defined as
$$x ( n ) = {\sum }_{m = 0}^{M - 1} {a}_{xh} ( m ) h ( n - m ) + {\sum }_{m = 0}^{M - 1} {a}_{xv} ( m ) v ( n - m )$$
$$y ( n ) = {\sum }_{m = 0}^{M - 1} {a}_{yh} ( m ) h ( n - m ) + {\sum }_{m = 0}^{M - 1} {a}_{yv} ( m ) v ( n - m )$$
and including maintaining values aₓₕ(m) and aₓᵥ(m) if the equalizer converges so x(n) and y(n) are the same signal, and otherwise resetting a_{yh}(m) and a_{yv}(m) as follows:
a_{yh}(m)=aₓᵥ*(M−m)
a_{yv}(m)=−aₓₕ*(M−m)

14. The method of claim 11 including equalizing average power of the two equalizer input signals.

15. Apparatus comprising:
a receiver for an optical transmission system which utilizes polarization multiplexing, the receiver including an adaptive equalizer for which dominant filters taps are maintained near a middle of a tap index range.

16. The apparatus of claim 15 wherein the taps are maintained by tuning the timing interpolation to minimize distance from tap center of mass to the middle of the tap index range.

17. The apparatus of claim 15 wherein the taps are maintained by shifting the equalizer taps if the distance from the taps center of mass to the middle of the tap index range exceeds a certain threshold.

18. A method comprising:
in a receiver for an optical transmission system which utilizes polarization multiplexing, the receiver including an adaptive equalizer, maintaining dominant filters taps near a middle of a tap index range.

19. The method of claim 18 including maintaining the taps by tuning the timing interpolation to minimize distance from tap center of mass to the middle of the tap index range.

20. The method of claim 18 wherein the taps are maintained by shifting the equalizer taps if the distance from the taps center of mass to the middle of the tap index range exceeds a certain threshold.

21. Apparatus comprising:
a receiver for an optical transmission system which utilizes polarization multiplexing, the receiver including an interpolation function followed by an adaptive equalizer function followed by a symbol timing error estimation function that feeds a control signal back to the interpolation function, wherein the interpolation function causes the adaptive equalizer function and symbol timing error estimation function to receive an integer number of samples per symbol.

22. The apparatus of claim 21 including a control loop with a feed-back signal from the symbol timing error estimation function which is used to fine tune the interpolation ratio so that the on-time samples at the output of the adaptive equalizer fall at the optimum sampling time in the middle of the eye.

23. A method comprising:
in a receiver for an optical transmission system which utilizes polarization multiplexing, the receiver including an interpolation function followed by an adaptive equalizer function followed by a symbol timing error estimation function that feeds a control signal back to the interpolation function, the interpolation function causing the adaptive equalizer function and symbol timing error estimation function to receive an integer number of samples per symbol.

24. The method of claim 23 utilizing a feed-back signal from the symbol timing error estimation function to fine tune the interpolation ratio so that the on-time samples at the output of the adaptive equalizer fall at the optimum sampling time in the middle of the eye.
